(19) United States
(12) Patent Application Publication
(10) Pub. No.: US 2025/0084213 A1
(43) Pub. Date: Mar. 13, 2025

(54) CONVERSION OF POLYETHYLENE TO POLYESTERS

(71) Applicant: Alliance for Sustainable Energy, LLC, Golden, CO (US)

(72) Inventors: Katrina Marie KNAUER, Denver, CO (US); Gregg Tyler BECKHAM, Golden, CO (US); Kevin M. WERNKE, Grand Junction, CO (US); Chad Thomas PALUMBO, Boulder, CO (US); Stephen Hughes DEMPSEY, Denver, CO (US)

(21) Appl. No.: 18/798,559

(22) Filed: Aug. 8, 2024

Related U.S. Application Data
(60) Provisional application No. 63/518,127, filed on Aug. 8, 2023.

(51) Int. Cl. C08G 65/48; C08G 67/00

(52) U.S. Cl. CPC C08G 65/48; C08G 67/00; C08G 2650/10

(57) ABSTRACT

Polyesters are an invaluable material used today and are considered more recyclable-by-design and biodegradable than polyolefins. Disclosed herein are methods for up-cycling of polyethylene (PE) to aliphatic polyesters via a two-step oxidative approach. The first step converts PE to a polyketone via a mild oxidation with a radical initiator, solvent, O₂, and cobalt catalyst. The second step converts the resulting ketone functionality to the ester via a Baeyer-Villiger oxidation.

### CROSS-REFERENCE TO RELATED APPLICATIONS

This application claims priority under 35 U.S.C. § 119 to U.S. provisional patent application No. 63/518,127 filed on 8 Aug. 2023, the contents of which are hereby incorporated in their entirety.

### CONTRACTUAL ORIGIN

This invention was made under a CRADA (CRD-22-22451) between Proctor & Gamble and the National Renewable Energy Laboratory operated for the United States Department of Energy. The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND

Polyethylene (PE) accounts for approximately 30% of the total amount of plastics, with 15 million tonnes of PE being produced in Europe each year. By 2020, in Europe, only 10% to 15% of high-density PE (HDPE) was recycled, and the current recycling rate for low-density PE (LDPE) is around 31%, leading to high environmental impacts. Thus, the circular economy model of production and consumption, which involves recycling by adding value to waste, has become popular and received much attention, especially for PE. Currently, mechanical recycling (primary and secondary), chemical recycling (tertiary), and energy recovery (quaternary) are the dominant techniques used to recycle waste PE. Chemical recycling of PE is considered very energy intensive and multiple energetic steps are required to recover the parent monomer of ethylene for repolymerization and reuse. One alternative method for the reuse or recycling of PE waste is by chemically converting PE into an entirely new, higher value, and more easily depolymerized (i.e., “recyclable-by-design”) polymer by conversion of the aliphatic C—H bonds into new linkers in the PE backbone. Ester bonds, for example, are much easier to break than the carbon-carbon bonds in PE and typically result in quantitative yields of monomers. A technology that can convert PE to a polyester will allow for lower energy and more selective depolymerization of PE waste into valuable building blocks. Additionally, incorporation of ester bonds may also yield a more biodegradable material.

### SUMMARY

In an aspect, disclosed herein are methods, systems and compositions of matter useful for conversion of polyethylene to polyesters by performing a first oxidative step on polyethylene and a second Baeyer-Villiger oxidation step on the product resulting from the first oxidative step.

Other objects, advantages, and novel features of the present invention will become apparent from the following detailed description of the invention when considered in conjunction with the accompanying drawings.

### BRIEF DESCRIPTION OF THE DRAWINGS

FIG. 1 depicts a representation of FTIR spectroscopy of ketone functionalized PE using varying radical initiators and catalysts.

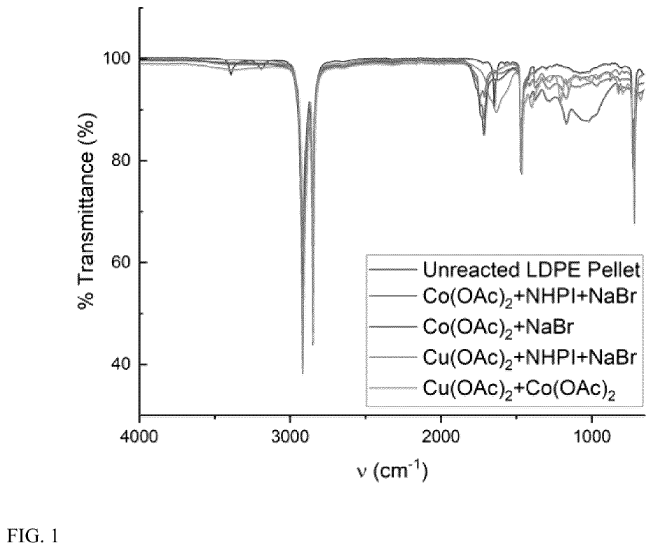

FIG. 2 depicts a comparison of 1 h O₂ aeration (black trace) vs. no O₂ aeration (red trace) on PE oxidation (aeration results in ketone functionality on PE backbone).

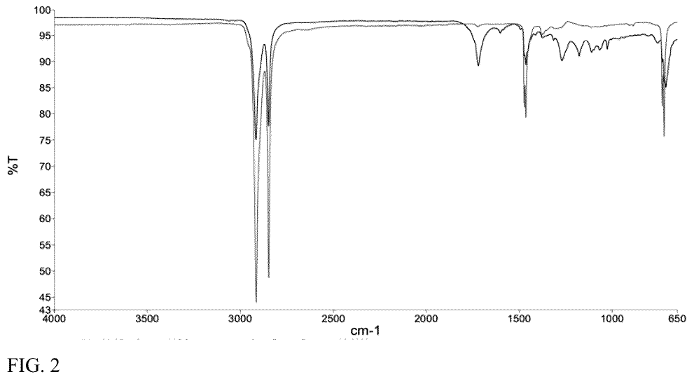

FIG. 3 depicts 1H NMR data of a polyester derived from oxidized PE via a reaction with meta-Chloroperoxybenzoic acid (mCPBA) at 22° C. for 6 days. The signal at 4 ppm corresponds to in-chain ester and was not present in the starting material.

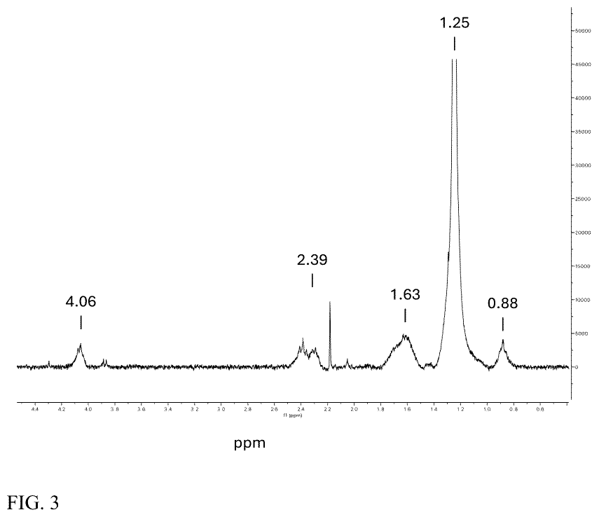

FIG. 4 depicts FTIR spectra of gel-phase oxidation conditions using various xylenes and oxidants as listed in Table 2 all using Cat: 5 wt % Co(OAc)₂+NaBr.

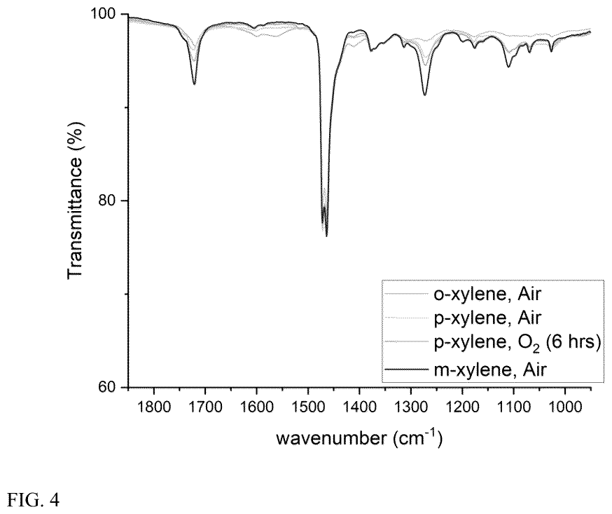

FIG. 5 depicts the FTIR spectrum of an exemplary product as depicted in Scheme 2.

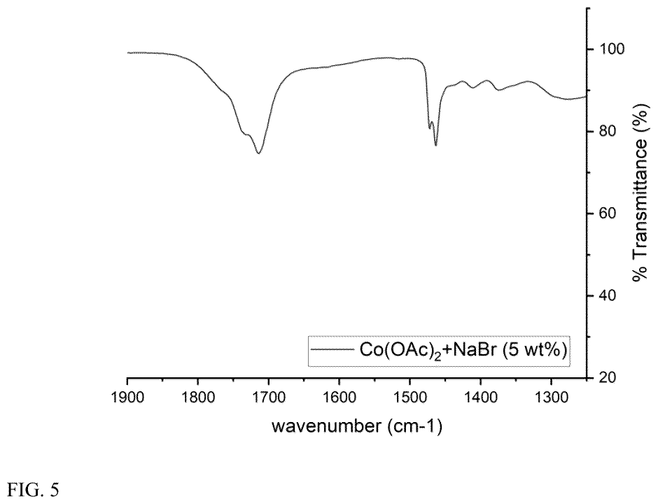

FIG. 6 depicts the solid state NMR spectrum of an exemplary product as depicted in Scheme 2.

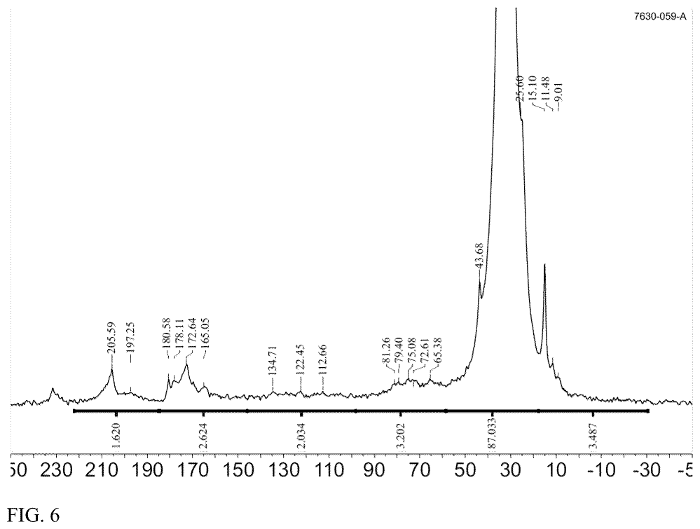

FIG. 7 depicts the stress vs. strain of the three different samples whose stress, strain and modulus are also depicted in Table 3.

FIG. 8 depicts the stress vs. strain average of the three different samples whose stress, strain and modulus are also depicted in Table 3.

### DETAILED DESCRIPTION

Post-consumer PE waste provides an abundant source of raw material for making new polymers and chemicals. This invention demonstrates that PE waste can be converted to a polyester via a two-step oxidative process. This process also provides a pathway for conversion of PE to other ionomers with varying side chain functionality including alcohols, maleic anhydride, acetates, etc. As depicted in Scheme 1, the first step is a mild oxidation that converts PE to a polyketone in the presence of a chlorinated solvent (such as tetrachloroethane (TCE) or trichlorobenzene), or xylene (or other aromatic solvents, e.g., naphthalene), radical initiator (NaBr or N-hydroxyphthalimide (NHPI)), and a cobalt catalyst with aeration using O₂ at 100-170° C. As depicted in Scheme 1, the second step converts the resulting ketone functionality to the ester (yielding a polyester) via a Baeyer-Villiger oxidation.

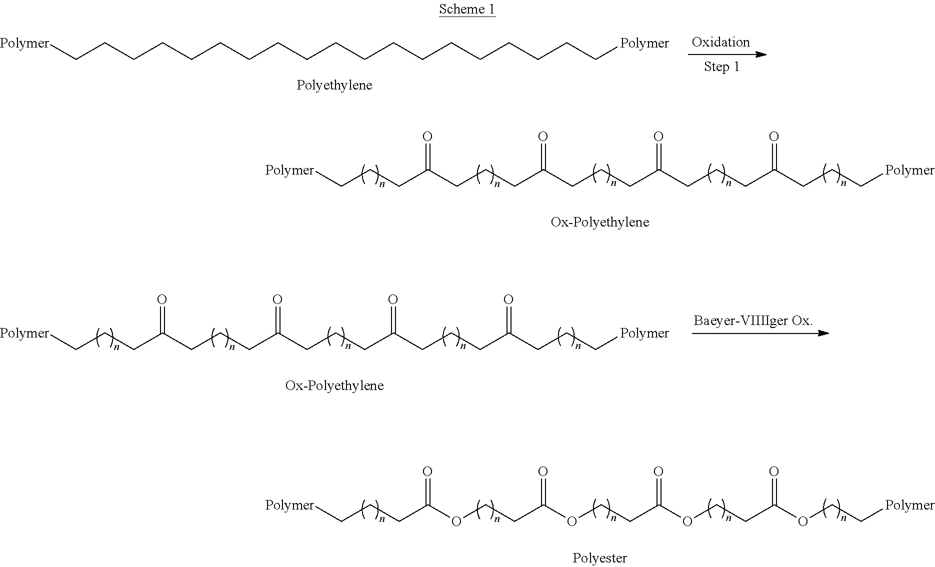

Additional solvents that can be used in the methods disclosed herein are depicted in Table 1.

TABLE 1

| | Solvent | | | | | | | | | |
|---|---|---|---|---|---|---|---|---|---|---|
| | | | Mineral | | Octanoic | | Decanoic | | Lauric | |
| | Napthalene | | Oil | | Acid | | Acid | | Acid | |
| Time to | 1 | hr | 3 | hrs | >6 | hrs | 1 | hr | 1 | hr |
| solubilize PE | | | | | | | | | | |
| Crash out | <80° | C. | 115° | C. | 115° | C. | 110° | C. | 95° | C. |
| temperature | | | | | | | | | | |
| for PE | | | | | | | | | | |

In an embodiment, the oxidation takes place in the gel-phase using various xylenes as a solvent and either oxygen or air as an oxidant, see Table 2.

TABLE 2

| Solvent | Oxidant | MW (kDa) | PDI |
|---|---|---|---|
| o-xylene | Air | 80.8 | 4.03 |
| p-xylene | Air | 77.1 | 3.77 |
| p-xylene | O2 | 41.1 | 3.42 |
| m-xylene | Air | 53.6 | 3.47 |

In another embodiment, the conditions depicted in Scheme 2 can be used to oxidize PE.

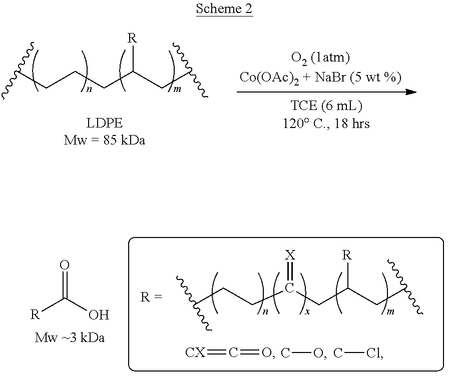

Using the conditions depicted in Scheme 2 can result in up to about 8.5% total functionalization. In an embodiment, the total functionalization comprises all C═O at about 4.3%; C═C at about 1%; and C—X at about 3.2%.

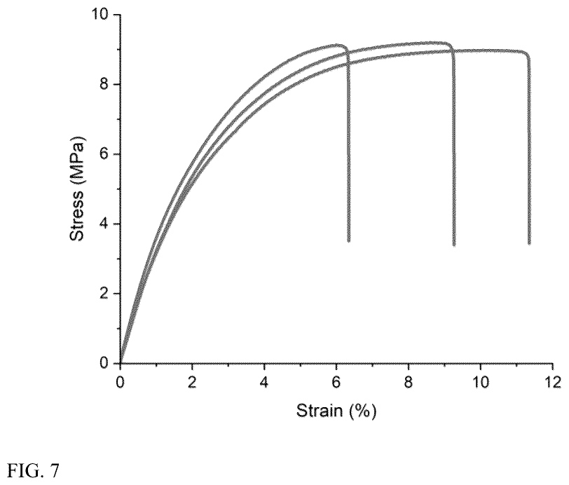

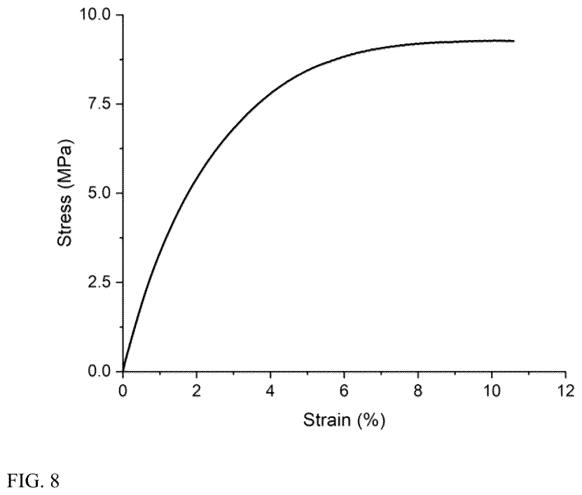

In an embodiment, the conditions depicted in Scheme 2 result in oxidized PE with properties depicted in Table 3 whose properties are also further depicted in FIGS. 7 and 8.

TABLE 3

| Sample | Stress (MPa) | Strain (%) | Modulus (MPa) |
|---|---|---|---|
| 1 | 9.20 | 9.27 | 404 |
| 2 | 8.98 | 11.4 | 345 |
| 3 | 9.13 | 6.34 | 348 |
| Average | 9.10 ± 0.11 | 8.99 ± 2.52 | 366 ± 33 |

Table 4 depicts the properties of different samples of PE oxidized under different conditions using varying solvents and oxidants.

TABLE 4

| | | TF % | TF % | | | | | |
|---|---|---|---|---|---|---|---|---|
| | | [C═O | [C═O | | | | | |
| | | %] | %] | MW | | | | |
| | | (13C- | (1H- | [PDI] | Tm | Stress | Strain | Modulus |
| Entry | Conditions | NMR) | NMR) | (kDa) | (° C.) | (MPa) | (MPa) | (MPa) |
| 1 | TCE, O2 | 8.5 | 3.7 | 3.56 | 107 | 9.1 | 8.99 | 366 |
| | | [4.3] | [0.3] | [2.50] | | | | |
| 2 | o-xyl, air | 4.2 | 0.8 | 80.8 | 112 | 10.1 | 24.7 | 225 |
| | | [1.6] | [0.3] | [4.04] | | | | |
| 3 | o-xyl, air | 2.3 | 0.6 | 77.1 | 112 | 10.1 | 239 | 206 |
| | | [0.6] | [0.3] | [3.77] | | | | |
| 4 | p-xy1, O2 | Don't | 1.0 | 41.1 | 112 | 10.3 | 58.3 | 263 |
| | | have | [0.5] | [3.42] | | | | |
| 5 | m-xyl, air | 4.3 | 0.5 | 53.6 | 109 | 8.93 | 110 | 210 |
| | | [1.1] | [0.4] | [3.47] | | | | |
| 6 | s.m. | 0 | 0 | 85.2 | 112 | 16.1 | 471 | 237 |
| | | | | [2.02] | | | | |

The first step can yield between 0.5-5% ketone functionality in the backbone of PE and can be tuned based on the catalyst loading, temperature, and solvent used. In the second step the ketone groups dispersed along the PE backbone are converted to an ester linkage via a Baeyer-Villiger oxidation (BVO). The BVO step entails exposing the polyketone from Step 1 to 100 wt % meta-chloroperoxybenzoic (mCPBA) in TCE at 22° C. (i.e., room temp) for 6 days which converts the oxidized PE substrate containing in-chain ketones to a polyester (verified by ¹H NMR).

In an embodiment, disclosed herein are methods, system and compositions of matter useful for up-cycling of polyethylene to polyesters via a two-step oxidative approach. The first step converts polyethylene to a polyketone in the presence of a benzaldehyde species, NHPI, Co(OAc)₂ with aeration using O₂ at 100° C. The second step converts the resulting ketone functionality to the ester via a Baeyer-Villiger oxidation.

Currently polyesters are accessed using virgin petroleum feed stocks. The upcycling of polyethylene waste into valuable polyesters is achievable using methods disclosed herein. Methods and processes disclosed herein are an improvement over existing oxidation of polyethylene using a benzldehyde oxidation system only access about 0.5% oxidized carbon. Systems disclosed herein result in can access up to about 4% oxidized carbon.

Full solubilization of PE facilitates its oxidation. This process is facile for LDPE in 1,1,2,2-tetrachloroethane and 1,2,4-trichlorobenzene, but they are toxic and an environmental hazard. Accordingly, in an embodiment, other solvents were used. Long chain carboxylic acids starting at C8, easily solubilize LDPE at the relevant temperature of 120° C., while aromatic hydrocarbons like xylene and naphthalene are also effective. Mineral oil can also be used. Raising the temperature to 140° C. enables solubilization of HDPE, albeit at a lower rate.

Subjecting 85 kDa LDPE to the oxidation conditions for 18 hours at 120° C. under 1 atm pure O₂, maximal oxidation was achieved using TCE as a solvent. Via solid state ¹³C NMR, the total functionalization (TF) of the material was 9.7%, with 4.2% being the desired carboxylic acids and internal ketones. The final dark brown polymer had a significantly reduced molecular weight of 3.56 kDA (via HT-GPC) with Ð=2.50, and its mechanical properties were significantly degraded compared to the starting material.

When less hazardous xylene was used as the solvent and air as the oxidant, a TF and carbonyl percentage of 4.2/1.6% was achieved in o-xylene, 2.3/0.6% in p-xylene, and 4.3/1.1% in m-xylene. In each of these cases, the molecular weight was significantly higher and mechanical properties were only slightly degraded. In their NMR spectra, large quantities of double bonds are evident which suggests some incorporation of xylene into the polymer backbone.

The foregoing disclosure has been set forth merely to illustrate the invention and is not intended to be limiting.

We claim:

1. A method for converting polyethylene into polyester comprising a first step of oxidizing polyethylene; and a second step of performing a Baeyer-Villiger oxidation upon the oxidized polyethylene resulting from step 1.

2. The method of claim 1 wherein the first step comprises reacting polyethylene in a chlorinated solvent wherein the chlorinated solvent comprises a radical initiator and a cobalt catalyst.

3. The method of claim 2 wherein the chlorinated solvent is selected from the group consisting of tetrachloroethane and trichlorobenzene.

4. The method of claim 2 wherein the radical initiator is selected from the group consisting of NaBr and N-hydroxyphthalimide.

5. The method of claim 2 wherein the cobalt catalyst is Co(OAc)₂.

6. The method of claim 1 wherein the first step of oxidizing polyethylene comprises aeration using O₂.

7. The method of claim 1 wherein the Baeyer-Villiger oxidation reaction comprises reacting meta-chloroperoxybenzoic (mCPBA) with the oxidized polyethylene resulting from step 1 in a chlorinated solvent.

8. The method of claim 7 wherein the Baeyer-Villiger oxidation reaction comprises using an amount of mCPBA that is 100 percent by weight to the oxidized polyethylene resulting from step 1.

9. The method of claim 1 wherein the first step takes place at a temperature of from about 100° C. to about 170° C.

10. The method of claim 1 wherein the second step takes place at a temperature of about 22° C.

11. The method of claim 1 wherein the second step takes over about 6 days.

12. The method of claim 1 wherein the first step comprises reacting polyethylene with N-hydroxyphthalimide in the presence of a benzaldehyde species and Co(OAc)₂.

13. The method of claim 1 wherein the polyethylene is oxidized at up to about 4 percent of its carbons after step 1.

14. The method of claim 1 wherein the polyethylene is oxidized at up to about 9 percent of its carbons after step 1.

15. A method for converting polyethylene into polyester comprising a first step of oxidizing polyethylene; and a second step of performing a Baeyer-Villiger oxidation upon the oxidized polyethylene resulting from step 1 wherein the first step comprises reacting polyethylene in an aromatic solvent comprising a radical initiator and a catalyst.

16. The method of claim 15 wherein the aromatic solvent is selected from the group consisting of xylenes and naphthalene.

17. The method of claim 15 wherein the radical initiator is selected from the group consisting of NaBr and N-hydroxyphthalimide.

18. The method of claim 15 wherein the catalyst is Co(OAc)₂.

19. The method of claim 15 wherein the first step of oxidizing polyethylene comprises aeration using O₂.

20. The method of claim 15 wherein the polyethylene is oxidized at up to about 9 percent of its carbons after step 1.
